(19) United States
(12) Patent Application Publication
(10) Pub. No.: US 2006/0233924 A1
(43) Pub. Date: Oct. 19, 2006

(54) Implement for adding ingredients to beverages

(76) Inventor: Kim Ha Nguyen, Garden Grove, CA (US)

Correspondence Address: PHILIP H. HAYMOND, 7545 IRVINE CENTER DRIVE, SUITE 200, IRVINE, CA, 92618-2933, US

(21) Appl. No.: 11/108,918

(22) Filed: Apr. 18, 2005

(51) Int. Cl. A23L 1/00

(52) U.S. Cl. 426/134

(57) ABSTRACT

An implement for introducing sugar and other ingredients into a liquid beverage is described. At least one granular ingredient such as sugar is molded to one end of an elongate member, allowing the user to both add to and stir beverages. Other ingredients and additives may optionally be used as well, using the granular ingredient as a binder.

### FIELD OF THE INVENTION

This invention relates to implements used to introduce additives to beverages and more particularly to a method and apparatus for adding sugar and other ingredients to hot beverages.

### BACKGROUND OF THE INVENTION

Sugar is a favorite additive used to sweeten coffee, tea and other hot beverages. Sucrose sugar, also known as table sugar, is usually used for this purpose, it is obtained mainly from sugar cane and sugar beets and used in many foods, drinks, and medicines to improve their taste. There are other common forms of sugar used for sweetening in cooking, for example dextrose and fructose.

There are many forms of sucrose sugar, depending on the grain size, the way the sugar was crystallized and ground, the purity with some having additives for flavoring or cooking conditions. Regular or table sugar, used for general cooking and dissolving in beverages has a grain size of about 0.3-0.5 mm. Larger grained sucrose sugar, commonly referred to as coarse, sanding or pearl sugars, have grain sizes of 1-2 mm are used in decorating baked goods. There are more finely granulated forms of sugar used in baking as well, having granules in the 0.1-0.3 mm range, they are sometimes referred to as bakers, fine, extra fine or superfine sugars. Confectioners or powdered sugar is a granulated sugar that has been crushed into a fine powder, individual crystals of 0.01-0.1 mm. Brown sugar usually includes molasses as a flavoring and may be made in different granular sizes.

A more complete discussion of sugar can be found in Harold McGee, On Food And Cooking, The Science And Lore Of The Kitchen, (New York, N.Y., Scribner pub. 2004) chapter 12, page 645 et. seq.

Sugar can be produced in forms other than as granulated sugar. Rock candy is an even larger form of sugar crystals, it is not generally considered to be granulated. It can be made by suspending the stick or string in a saturated sugar solution, allowing the crystals to form on the string or stick. Spun or cotton candy can be made by melting sugar and using a special apparatus to force it through spinnerets into the air, where it instantly solidifies as threads.

Granulated table sugar is free flowing and dissolves quickly in a liquid beverage and so is a favorite for sweetening beverages. This sweetener is therefore the most common form both for table use and for cooking. Also favored are also artificial sugar substitutes such as aspartame and saccharine that are produced in a granulated form for quick dissolution in beverages. The granulated form of sugars and sugar substitutes may be referred to collectively as “granulated beverage sweeteners;” the term “granulated beverage ingredients” refers to these sweeteners as well as other granulated beverage additives and ingredients.

Granulated sugar is also available in cubes or tablets of various sizes. A method of making sugar shapes such as cubes is to moisturize dry granulated sugar with a spray of water and thoroughly mix the slurry. The wet sugar contains about 1% water and is quite sticky at this stage. To make the cubes the moist sugar is pressed into molds and the molded sugar is then dried to leave a free standing shaped cube-shaped clump or agglutinate of sugar. There are other methods and variations of the above of make shaped or molded granulated sugar that will be apparent to those of skill in the art. Shaped or molded granulated sugar products such as sugar cubes may be referred to as “molded sugar.” More generally the term “molded beverage sweeteners” can be used to describe molded sugar and sugar substitutes; the term “molded beverage ingredients” for the molded sweeteners and also other beverage additives and ingredients as well.

Although granulated sugar and granulated sugar substitutes are favored for their ability to dissolve into a beverage a long-standing problem arises in the way granulated sugar is delivered to a user. There are currently several common methods of delivering a portion of sugar to a beverage. Granulated beverage sweeteners are currently packaged in several different ways to provide it for users to add to their drinks. The sugar may be left in bulk, in a bowl or jar to allow a user to scoop or pour a portion of sugar into their beverage, the user then stirs the beverage with a spoon or other second implement to accelerate the dissolution of the sugar in the beverage. Packets of pre-measured portions of granulated beverage sweeteners are also commonly provided to allow a user to add sugar to their drinks. Again, after adding the sugar from the packet to the drink, the user must use a second implement such as a spoon or a stick to stir the beverage to dissolve the sugar. Sugar cubes and other molded sugar products are also used, where the user adds one or more shaped sugars to the beverage, again using a second implement to stir the beverage.

Dodd, U.S. Pat. No. 4,215,628 and Lovell, U.S. Pat. No. 3,154,418 are complicated implements having chambers or racks retaining beverage ingredients. The implement is placed in a liquid to introduce the beverage ingredients to the liquid. Various attempts have been made to incorporate a sugar or sugar substitute with the stirring implement itself. For example a stick having rock candy on for this purpose it is offered by several manufacturers, such as the Rock Candy sugar Swizzle Stick product offered by the Dryden and Palmer company of Branford, Conn. Rock candy, because of its large size takes longer to dissolve in a liquid. One can speculate that it is for this reason rock candy sticks for beverages do not enjoy the popularity of other, they are more of a novelty item. Another implement of mention is made by the Plant Research Corporation of Waimanalo, Hi., who offer their Sugar Cane Swizzle Stick product for this purpose, a length of raw sugar cane.

Implements for introducing honey into a beverage are known as well, for example a honey server having a series of disks to retain honey, where a user dips the server into the honey then allows it to drip into the beverage. Another common implement is a honey spoon having a curve in the handle adapted to balance it on the lip of a cup, the spoon is dipped in the honey and the honey is allowed to drip into the cup while the spoon is balanced on the lip of the cup.

It would also be desirable then to have a single implement that could be used to introduce granulated beverage sweeteners and other ingredients or additives to a beverage.

Powdered coffees and teas suffer from the same need for a second implement to introduce them into a liquid, other powdered additives are widely used as well, such as powdered milk or the non-dairy powdered creamer Coffee Mate® product made by the Nestle USA corporation of Glendale, Calif.

What is needed then is a simplifying implement that can be used to both introduce and stir granulated beverage sweeteners such as sugar, sugar substitutes and other beverage ingredients or additives themselves into a liquid to create a beverage, without the need for a separate secondary supply of implements such as spoons or swizzle sticks.

### SUMMARY OF THE INVENTION

A solution to the above has been devised. A stirring or swizzle stick, an implement for introducing one or more ingredients into a liquid beverage, is provided having a molded granulated beverage sweetener affixed to one end. Although sucrose sugar may be used, other ingredients such as coffee, tea or additives may be used as well. Generally, an ingredient is made from granulated or powdered material that is compressed, or wetted and allowed to clump and form a mass, providing one or more granulated ingredients for dissolving in a liquid beverage.

The implement has a handle end and an ingredient end and may be straight or curved. The handle end may be formed to be hung from the lip of a beverage container such as a teacup, or the implement may be formed in another configuration to allow the implement to be in a substantially fixed orientation relative the liquid in the container. The ingredient end of the implement, having the ingredient, can be formed as a simple rod or to be flat to act as a paddle or even as a spoon to both stir the beverage and scoop other materials. It is envisioned that the ingredient end can be formed in a multitude of convenient shapes depending on the specific application.

Although sugar is used in the preferred embodiment, the ingredients may be other granulated or powdered beverage ingredients that are made in a manner similar to that of molded sugar cubes, where the ingredient is first wetted then allowed to clump to form a clump or mass onto the implement. Further, a known clumping ingredient can be combined with a non-clumping ingredient to use the clumping ingredient as a binder, to bind the non-clumping ingredient to the implement.

### BRIEF DESCRIPTION OF THE DRAWINGS

FIG. 1 are side views of embodiments of the present invention.

FIG. 2 illustrates a method of the present invention.

FIG. 3 illustrates another method of the present invention.

FIG. 4 is a side view of another embodiment of the present invention.

FIG. 5 is a side view of yet another embodiment of the present invention.

FIG. 6 is a side view of another embodiment of the present invention.

### DESCRIPTION OF THE INVENTION

The following description, and the figures to which it refers, are provided for the purpose of describing examples and specific embodiments of the invention only and are not intended to exhaustively describe all possible examples and embodiments of the invention.

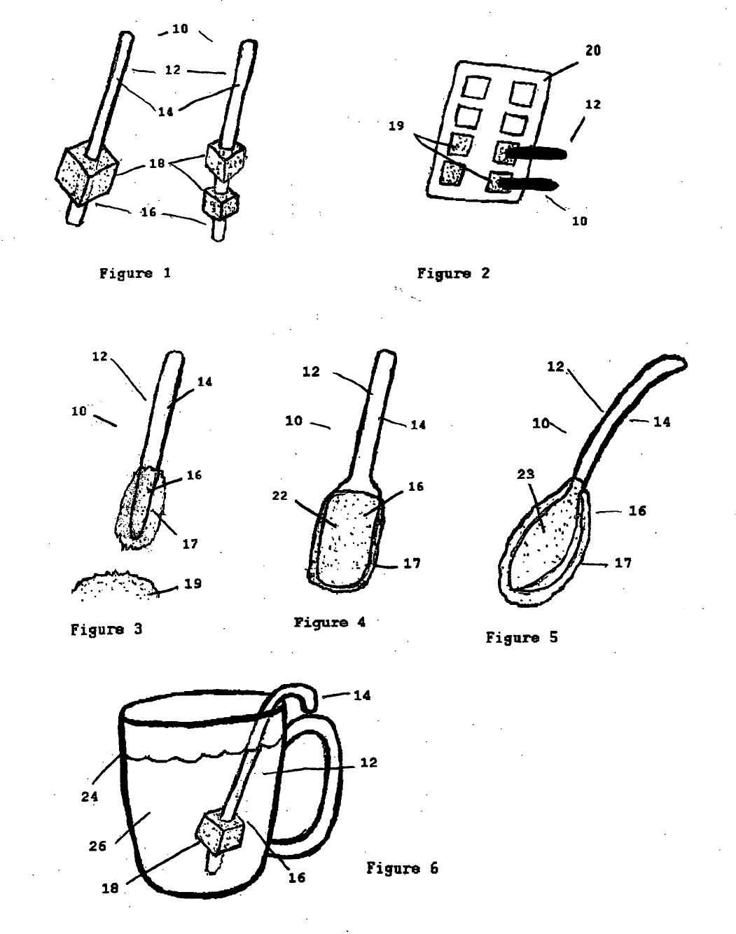

Referring now to FIG. 1 an implement 10 for adding sugar and/or other granulated beverage ingredients to a beverage is shown. In this embodiment, the ingredient 17 is a sugar cube 18, shown for context with respect to the prior art. An elongate member 12 forming a handle end 14 and an ingredient end 16 is shown. An ingredient 17, here a common sugar cube 18 is employed in this embodiment. The sugar cube in this example is a molded cube of granulated ingredient, granulated sucrose sugar.

Ingredients as used herein, includes at least one granulated material such as sugar, coffee, powdered milk, collectively granulated beverage ingredients. One or more granulated beverage ingredients are allowed to clump or are compressed into a clump, onto the elongate member 12, in a shape such as a sugar cube.

Referring further to FIG. 2 a method of making molded sugar is shown. Dry granulated sugar is mixed with a small amount of water to create a slurry and placed in molds 20. To make the cubes 18 the moist sugar 19 is pressed into the molds 20 and the ingredient end 12 of the elongate member 12 is placed in the drying sugar cubes 18. The molded sugar then continues to dry to leave a free-form shaped cube of sugar with the implement 10 affixed. There are other methods and variations of the above method for making molded granulated sugar that will be apparent to those of skill in the art. For example, as shown in FIG. 3, alternatively the implement can be immersed in un-molded wetted granular sugar 19 which is then allowed to dry in free form on the elongate member 12. It is preferable to mold an ingredient such as granulated molded sugar to the implement, rather than immersing the implement to create a free formed clump of ingredient because a predetermined portion size can be placed in a mold, more easily measuring the size of the portion.

FIG. 4 shows another embodiment of the implement 10. In this embodiment, the ingredient end 16 is formed as a flattened surface, which can be used as a paddle 22 to facilitate the stirring of the ingredient into the liquid. The flattened paddle 22 area also provides an increased surface area, both to retain more ingredients 17, and to increase the rate of solvation of the ingredients. FIG. 5 shows another embodiment of the implement 10. In this embodiment, the ingredient end 16 is formed as a spoon 23, which can be used as a much like the paddle 22 to facilitate the stirring of the ingredient into the liquid. The spoon 23 area also provides an even increased surface area. A broader surface area of the ingredient end 16 of the implement affords a larger surface area to hold more ingredients 17; a broader surface area also allows a greater surface area of the held ingredient 17 to be exposed to a beverage liquid, to increase the rate of solvatation.

FIG. 6 shows the handle end 14 of the elongate member 12 curved to allow it to be hung over the lip of a beverage container such as coffee mug or tea cup 24. This allows the implement 10 to be retained in a substantially fixed position in the liquid 26 in the beverage container. Other configurations of the handle end 14 to retain the implement 10 in a substantially fixed orientation with respect to the liquid are possible as well.

While the preferred embodiment is for an implement 10 using granulated sucrose sugar for an ingredient 17, other ingredients may be used as well. Any granular or powdered ingredient can be used, such as powdered coffee, powdered tea, powdered milk or other ingredients can be used, if they can be wetted and adhere to an implement. Alternatively a non-sucrose sugar ingredient can be combined with adhering ingredient, such as sucrose sugar, to use the adhering ingredient as a binder for holding the non-adhering ingredient.

It will be appreciated that the invention has been described hereabove with reference to certain examples or preferred embodiments as shown in the drawings. Various additions, deletions, changes and alterations may be made to the above-described embodiments and examples without departing from the intended spirit and scope of this invention.

Accordingly, it is intended that all such additions, deletions, changes and alterations be included within the scope of the following claims.

What is claimed is:

1) An implement for introducing one or more ingredients into a beverage, comprising:
an elongate member forming a handle end and an ingredient end, the ingredient end having a clump of one or more granular beverage ingredients affixed thereto.

2) The implement of claim 1 where the ingredient end is formed as a flattened surface or a spoon.

3) The implement of claim 1 where the handle end is adapted to retain the implement in a substantially fixed position in a beverage container.

4) The implement of claim 2 where the adaptation of the handle end is a curved handle end that allows the implement to be hung on the lip of the beverage container.

5) The implement of claim 1 where the ingredients include clumped granulated sucrose sugar affixed to the ingredient end.

6) The implement of claim 5 where the clumped granulated sucrose sugar is molded.

7) The implement of claim 5 where the ingredient further includes non-sucrose sugar beverage ingredients.

8) The implement of claim 7 where the clumped granulated sucrose sugar acts as a binder to retain a non-sucrose sugar beverage ingredient on the implement.

9) The implement of claim 1 where the ingredients consist of non-sucrose sugar beverage ingredients.

10) A method for providing an implement for introducing an ingredient into a beverage, comprising the steps of:
providing an elongate member forming a handle end and an ingredient end of the elongate member,
affixing a clump of one or more granulated ingredients to the ingredient end of the elongate member that has been clumped.

11) The method of claim 10, where the ingredient end is affixed to the clump of ingredients by placing the ingredient end into a portion of ingredients while the portion is moist and allowing the ingredients to dry, whereby the portion adheres to the ingredient end of the elongate member.

12) The method of claim 11, further comprising the step of placing the moist portion of ingredients into a mold.

13) The method of claim 10, where the ingredient end is formed as a flattened surface or a spoon.

14) The method of claim 10 where the handle end is adapted to retain the implement in a substantially fixed position in a beverage container.

15) The method of claim 14 where the handle end is curved to be hung on the lip of the beverage container.

16) The method of claim 10 where the ingredients include granulated sucrose sugar.

17) The method of claim 10 where the ingredients include granulated sucrose sugar and a non-sucrose sugar beverage ingredient and the sucrose sugar acts as a binder to retain the non-sucrose sugar beverage ingredient on the implement.

18) The method of claim 10 where the ingredients consist of non-sucrose beverage ingredients.

19) The method of claim 10, further including the step of a user grasping the handle end immersing the ingredient end into a liquid, whereby the ingredients dissolve in the liquid.
